(19) United States
(12) Patent Application Publication
(10) Pub. No.: US 2017/0265105 A1
(43) Pub. Date: Sep. 14, 2017

(54) COEXISTENCE THROUGH USE OF LESS POWER CONSTRAINED ASSISTED DEVICES

(71) Applicants: Shahrnaz Azizi, Cupertino, CA (US); Eldad Perahia, Portland, OR (US); Thomas J. Kenney, Portland, OR (US); Minyoung Park, Portland, OR (US)

(72) Inventors: Shahrnaz Azizi, Cupertino, CA (US); Eldad Perahia, Portland, OR (US); Thomas J. Kenney, Portland, OR (US); Minyoung Park, Portland, OR (US)

(21) Appl. No.: 15/274,897

(22) Filed: Sep. 23, 2016

Related U.S. Application Data
(60) Provisional application No. 62/307,661, filed on Mar. 14, 2016.

(51) Int. Cl. H04W 28/20; H04W 48/12; H04W 76/02; H04L 5/00; H04W 8/26; H04W 28/02

(52) U.S. Cl. CPC H04W 28/20; H04W 8/26; H04W 28/0215; H04W 76/023; H04L 5/0055; H04W 48/12; H04W 84/12

(57) ABSTRACT

Devices and methods of providing communications between a Low-Power (LP) STA and an Assisting STA are generally described. Different TXOPs are used for communication with the LP STA with an AP. A wideband preamble is transmitted on a 20 MHz channel and a narrowband trigger frame on a 2 MHz subchannel of the channel. A narrowband response is transmitted from the LP STA to the Assisting STA in response to transmission of the trigger frame. The response contains predetermined duration of data and an address of the Assisting STA and/or AP. The response potentially has a transmission range less than a distance from the LP STA to the AP. A narrowband ACK is transmitted in response to reception of the response. The trigger frame, the response and the ACK use the same subchannel. After reception of the response, a wideband communication containing the data is transmitted from the Assisting STA to the AP.

### PRIORITY CLAIM

This application claims the benefit of priority to U.S. Provisional Patent Application Ser. No. 62/307,661, filed Mar. 14, 2016, and entitled “COEXISTENCE THROUGH USE OF LESS POWER CONSTRAINED ASSISTED DEVICES,” which is incorporated herein by reference in its entirety.

### TECHNICAL FIELD

Embodiments pertain to wireless communications. Some embodiments relate to wireless local area networks (WLANs) and Wi-Fi networks including networks operating in accordance with the IEEE 802.11 family of standards, such as the IEEE 802.11ax standard. Some embodiments relate to improving coexistence between stations (STAs) having different communication requirements.

### BACKGROUND

The use of personal communication devices has increased astronomically over the last two decades. The penetration of mobile devices and other STAs in modern society has continued to drive demand for a wide variety of networked devices in a number of disparate environments. The use of networked STAs using a variety of communication protocols and in a variety of networks has proliferated in all areas of home and work life. A particularly rapid surge has been seen recently in use of small non-rechargeable battery operated STAs, referred to as Low Power STAs (LP STAs), used in the Internet of Things (IoT). There are a number of cases in which various types of STAs would like to communicate with each other. While communications between normal STAs, such as cell phones, may be readily achieved, communications with LP STAs may present an issue. In particular, LP STAs may not have sufficient power for communications or may use narrow bandwidth that may be incompatible with other STAs. This may lead to coexistence issues between the STAs.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1 is a wireless network in accordance with some embodiments.

FIG. 2 illustrates components of a communication device in accordance with some embodiments.

FIG. 3 illustrates a block diagram of a communication device in accordance with some embodiments.

FIG. 4 illustrates another block diagram of a communication device in accordance with some embodiments.

FIG. 5 illustrates a home environment in accordance with some embodiments.

FIG. 6 illustrates a multi-room environment in accordance with some embodiments.

FIG. 7 illustrates system communications in accordance with some embodiments.

FIG. 8 is a flowchart of a communications between an Assisting STA and a LP STA in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

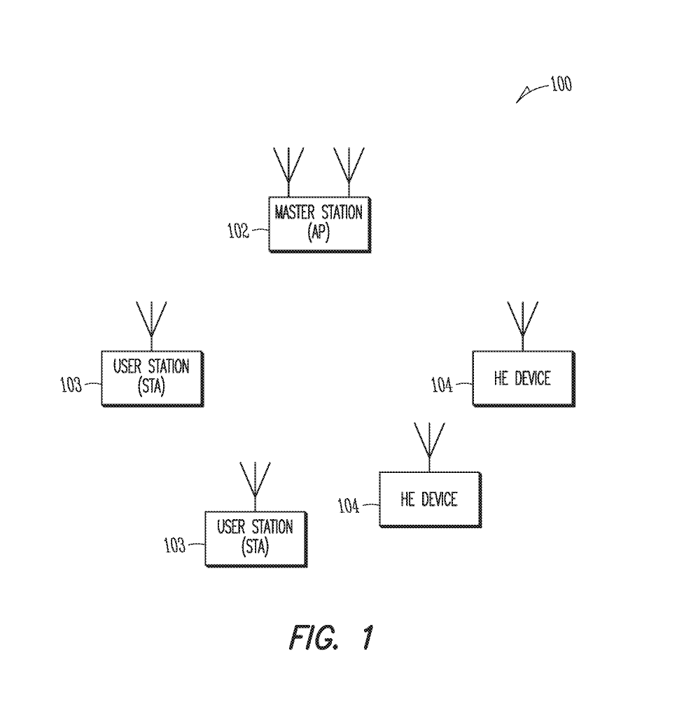

FIG. 1 illustrates a wireless network in accordance with some embodiments. In The network 100 may be an Enhanced Directional Multi Gigabit (EDMG) network, a High Efficiency Wireless Local Area Network (HE) network, and/or a Wireless Local Area Network (WLAN) or a Wi-Fi network. As an example, the network 100 may support EDMG devices in some cases, non EDMG devices in some cases, and a combination of EDMG devices and non EDMG devices in some cases. As another example, the network 100 may support HE devices in some cases, non HE devices in some cases, and a combination of HE devices and non HE devices in some cases. As another example, some devices supported by the network 100 may be configured to operate according to EDMG operation and/or HE operation and/or legacy operation. Accordingly, it is understood that although techniques described herein may refer to a non EDMG device, an EDMG device, a non HE device or an HE device, such techniques may be applicable to any or all such devices in some cases.

The network 100 may include any number (including zero) of master stations (STA) 102, user stations (STAs) 103, HE stations 104 (HE devices), and EDMG stations 105 (EDMG devices). The master station 102 may be a stationary non-mobile device, such as an access point (AP). In some embodiments, the STAs 103 may be legacy stations, Assisting STAs as described below or LP STAs. These embodiments are not limiting, however, as the STAs 103 may be HE devices or may support HE operation in some embodiments. In some embodiments, the STAs 103 may be EDMG devices or may support EDMG operation. It should be noted that embodiments are not limited to the number of master STAs 102, STAs 103, HE stations 104 or EDMG stations 105 shown in the example network 100 in FIG. 1. The master station 102 may be arranged to communicate with the STAs 103 and/or the HE stations 104 and/or the EDMG stations 105 in accordance with one or more of the IEEE 802.11 standards. In accordance with some HE embodiments, an AP may operate as the master station 102 and may be arranged to contend for a wireless medium (e.g., during a contention period) to receive exclusive control of the medium for an HE control period (i.e., a transmission opportunity (TXOP)). The master station 102 may, for example, transmit a master-sync or control transmission at the beginning of the HE control period to indicate, among other things, which HE stations 104 are scheduled for communication during the HE control period. During the HE control period, the scheduled HE stations 104 may communicate with the master station 102 in accordance with a non-contention based multiple access technique. This is unlike conventional Wi-Fi communications in which devices communicate in accordance with a contention-based communication technique, rather than a non-contention based multiple access technique. During the HE control period, the master station 102 may communicate with HE stations 104 using one or more HE frames. During the HE control period, STAs 103 not operating as HE devices may refrain from communicating in some cases. In some embodiments, the master-sync transmission may be referred to as a control and schedule transmission.

In some embodiments, the multiple-access technique used during the HE control period may be a scheduled orthogonal frequency division multiple access (OFDMA) technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique including a multi-user (MU) multiple-input multiple-output (MIMO) (MU-MIMO) technique. These multiple-access techniques used during the HE control period may be configured for uplink or downlink data communications.

The master station 102 may also communicate with STAs 103 and/or other legacy stations in accordance with legacy IEEE 802.11 communication techniques. In some embodiments, the master station 102 may also be configurable to communicate with the HE stations 104 outside the HE control period in accordance with legacy IEEE 802.11 communication techniques, although this is not a requirement. The master station 102 may form a Basic Service Set (BSS) with the other STAs 103, 104, 105 having a BSSID and communicating using IEEE 802.11 protocols (using an IEEE 802.11a/b/g/n/ac or ax protocol) in a Wireless Local Area Network (WLAN) or Wi-Fi network.

In some embodiments, the HE communications during the control period may be configurable to use one of 20 MHz, 40 MHz, or 80 MHz or 160 MHz contiguous bandwidths or an 80+80 MHz (160 MHz) non-contiguous bandwidth. In some embodiments, a 320 MHz channel width may be used. In some embodiments, subchannel bandwidths less than 20 MHz may also be used. In these embodiments, each channel or subchannel of an HE communication may be configured for transmitting a number of spatial streams.

In some embodiments, EDMG communication may be configurable to use channel resources that may include one or more frequency bands of 2.16 GHz, 4.32 GHz or other bandwidth. Such channel resources may or may not be contiguous in frequency. As a non-limiting example, EDMG communication may be performed in channel resources at or near a carrier frequency of 60 GHz.

In some embodiments, primary channel resources may include one or more such bandwidths, which may or may not be contiguous in frequency. As a non-limiting example, channel resources spanning a 2.16 GHz or 4.32 GHz bandwidth may be designated as the primary channel resources. As another non-limiting example, channel resources spanning a 20 MHz bandwidth may be designated as the primary channel resources. In some embodiments, secondary channel resources may also be used, which may or may not be contiguous in frequency. As a non-limiting example, the secondary channel resources may include one or more frequency bands of 2.16 GHz bandwidth, 4.32 GHz bandwidth or other bandwidth. As another non-limiting example, the secondary channel resources may include one or more frequency bands of 20 MHz bandwidth or other bandwidth.

In some embodiments, the primary channel resources may be used for transmission of control messages, beacon frames or other frames or signals by the AP 102. As such, the primary channel resources may be at least partly reserved for such transmissions. In some cases, the primary channel resources may also be used for transmission of data payloads and/or other signals. In some embodiments, the transmission of the beacon frames may be restricted such that the AP 102 does not transmit beacons on the secondary channel resources. Accordingly, beacon transmission may be reserved for the primary channel resources and may be restricted and/or prohibited in the secondary channel resources, in some cases.

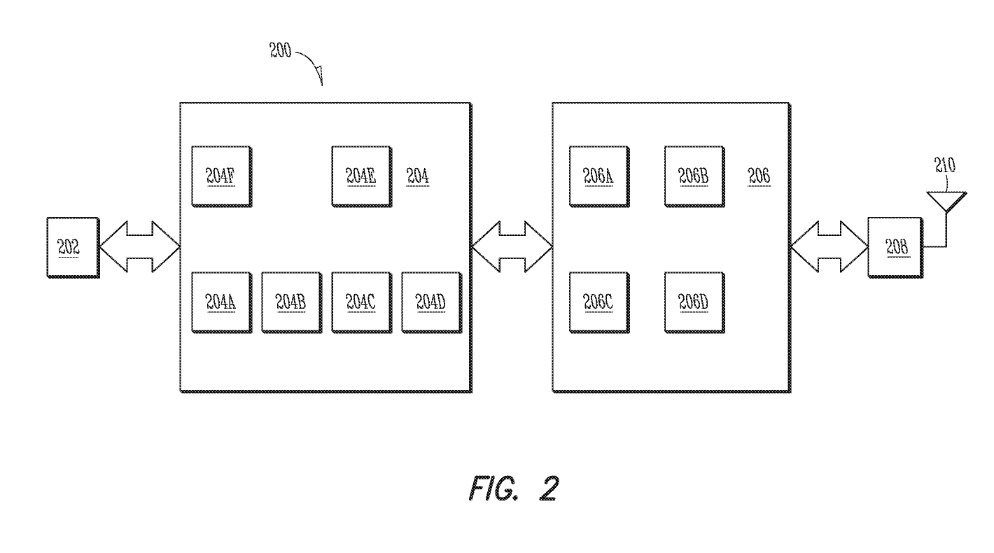

Embodiments described herein may be implemented into a system using any suitably configured hardware and/or software. FIG. 2 illustrates components of a STA in accordance with some embodiments. At least some of the components shown may be used in an AP, for example, such as the STA 102 or AP 104 shown in FIG. 1. The STA 200 may be a LP STA as described herein. The application or processing circuitry 202 may include one or more application processors. For example, the application circuitry 202 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 204 may include circuitry such as, but not limited to, one or more single-core or multi-core processors. The baseband circuitry 204 may include one or more baseband processors and/or control logic to process baseband signals received from a receive signal path of the RF circuitry 206 and to generate baseband signals for a transmit signal path of the RF circuitry 206. Baseband processing circuitry 204 may interface with the application circuitry 202 for generation and processing of the baseband signals and for controlling operations of the RF circuitry 206. For example, in some embodiments, the baseband circuitry 204 may include a second generation (2G) baseband processor 204a, third generation (3G) baseband processor 204b, fourth generation (4G) baseband processor 204c, and/or other baseband processor(s) 204d for other existing generations, generations in development or to be developed in the future (e.g., fifth generation (5G), 6G, etc.). The baseband circuitry 204 (e.g., one or more of baseband processors 204a-d) may handle various radio control functions that enable communication with one or more radio networks via the RF circuitry 206. The radio control functions may include, but are not limited to, signal modulation/demodulation, encoding/decoding, radio frequency shifting, etc. In some embodiments, modulation/baseband circuitry demodulation circuitry of the 204 may include Fast-Fourier Transform (FFT), precoding, and/or constellation mapping/demapping functionality. In some embodiments, encoding/decoding circuitry of the baseband circuitry 204 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 204 may include elements of a protocol stack such as, for example, elements of an evolved universal terrestrial radio access network (EUTRAN) protocol including, for example, physical (PHY),media access control (MAC), radio link control (RLC), packet data convergence protocol (PDCP), and/or radio resource control (RRC) elements. A central processing unit (CPU) 204e of the baseband circuitry 204 may be configured to run elements of the protocol stack for signaling of the PHY, MAC, RLC, PDCP and/or RRC layers. In some embodiments, the baseband circuitry may include one or more audio digital signal processor(s) (DSP) 204f. The audio DSP(s) 204f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 204 and the application circuitry 202 may be implemented together such as, for example, on a system on a chip (SOC).

In some embodiments, the baseband circuitry 204 may provide for communication compatible with one or more radio technologies. For example, in some embodiments, the baseband circuitry 204 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 204 is configured to support radio communications of more than referred to as multi one wireless protocol may be-mode baseband circuitry. In some embodiments, the STA 200 can be configured to operate in accordance with communication standards or other protocols or standards, including Institute of Electrical and Electronic Engineers (IEEE) 802.16 wireless technology (WiMax), IEEE 802.11 wireless technology (WiFi) including 802.11 ax, various other wireless technologies such as global system for mobile communications (GSM), enhanced data rates for GSM evolution (EDGE), GSM EDGE radio access network (GERAN), universal mobile telecommunications system (UMTS), UMTS terrestrial radio access network (UTRAN), or other 2G, 3G, 4G, 5G, etc. technologies either already developed or to be developed.

RF circuitry 206 may enable communication with wireless networks using modulated electromagnetic radiation through a non-solid medium. In various embodiments, the RF circuitry 206 may include switches, filters, amplifiers, etc. to facilitate the communication with the wireless network. RF circuitry 206 may include a receive signal path which may include circuitry to down-convert RF signals received from the FEM circuitry 208 and provide baseband signals to the baseband circuitry 204. RF circuitry 206 may also include a transmit signal path which may include circuitry to up-convert baseband signals provided by the baseband circuitry 204 and provide RF output signals to the FEM circuitry 208 for transmission.

In some embodiments, the RF circuitry 206 may include a receive signal path and a transmit signal path. The receive signal path of the RF circuitry 206 may include mixer circuitry 206a, amplifier circuitry 206b and filter circuitry 206c. The transmit signal path of the RF circuitry 206 may include filter circuitry 206c and mixer circuitry 206a. RF circuitry 206 may also include synthesizer circuitry 206d for synthesizing a frequency for use by the mixer circuitry 206a of the receive signal path and the transmit signal path. In some embodiments, the mixer circuitry 206a of the receive signal path may be configured to down-convert RF signals received from the FEM circuitry 208 based on the synthesized frequency provided by synthesizer circuitry 206d. The amplifier circuitry 206b may be configured to amplify the down-converted signals and the filter circuitry 206c may be a low-pass filter (LPF) or band-pass filter (BPF) configured to remove unwanted signals from the down-converted signals to generate output baseband signals. Output baseband signals may be provided to the baseband circuitry 204 for further processing. In some embodiments, the output baseband signals may be zero-frequency baseband signals, although this is not a requirement. In some embodiments, mixer circuitry 206a of the receive signal path may comprise passive mixers, although the scope of the embodiments is not limited in this respect.

In some embodiments, the mixer circuitry 206a of the transmit signal path may be configured to up-convert input baseband signals based on the synthesized frequency provided by the synthesizer circuitry 206d to generate RF output signals for the FEM circuitry 208. The baseband signals may be provided by the baseband circuitry 204 and may be filtered by filter circuitry 206c. The filter circuitry 206c may include a low-pass filter (LPF), although the scope of the embodiments is not limited in this respect.

In some embodiments, the mixer circuitry 206a of the receive signal path and the mixer circuitry 206a of the transmit signal path may include two or more mixers and may be arranged for quadrature downconversion and/or upconversion respectively. In some embodiments, the mixer circuitry 206a of the receive signal path and the mixer circuitry 206a of the transmit signal path may include two or more mixers and may be arranged for image rejection (e.g., Hartley image rejection). In some embodiments, the mixer circuitry 206a of the receive signal path and the mixer circuitry 206a may be arranged for direct downconversion and/or direct upconversion, respectively. In some embodiments, the mixer circuitry 206a of the receive signal path and the mixer circuitry 206a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 206 may include analog-to-digital converter (ADC) and digital-to-analog converter (DAC) circuitry and the baseband circuitry 204 may include a digital baseband interface to communicate with the RF circuitry 206.

In some dual-mode embodiments, a separate radio IC circuitry may be provided for processing signals for each spectrum, although the scope of the embodiments is not limited in this respect.

In some embodiments, the synthesizer circuitry 206d may be a fractional-N synthesizer or a fractional N/N+1 synthesizer, although the scope of the embodiments is not limited in this respect as other types of frequency synthesizers may be suitable. For example, synthesizer circuitry 206d may be a delta-sigma synthesizer, a frequency multiplier, or a synthesizer comprising a phase-locked loop with a frequency divider.

The synthesizer circuitry 206d may be configured to synthesize an output frequency for use by the mixer circuitry 206a of the RF circuitry 206 based on a frequency input and a divider control input. In some embodiments, the synthesizer circuitry 206d may be a fractional N/N+1 synthesizer.

In some embodiments, frequency input may be provided by a voltage controlled oscillator (VCO), although that is not a requirement. Divider control input may be provided by either the baseband circuitry 204 or the applications processor 202 depending on the desired output frequency. In some embodiments, a divider control input (e.g., N) may be determined from a look-up table based on a channel indicated by the applications processor 202.

Synthesizer circuitry 206d of the RF circuitry 206 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 206d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (f_{LO}). In some embodiments, the RF circuitry 206 may include an IQ/polar converter.

FEM circuitry 208 may include a receive signal path which may include circuitry configured to operate on RF signals received from one or more antennas 210, amplify the received signals and provide the amplified versions of the received signals to the RF circuitry 206 for further processing. FEM circuitry 208 may also include a transmit signal path which may include circuitry configured to amplify signals for transmission provided by the RF circuitry 206 for transmission by one or more of the one or more antennas 210.

In some embodiments, the FEM circuitry 208 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 206). The transmit signal path of the FEM circuitry 208 may include a power amplifier (PA) to amplify input RF signals (e.g., provided by RF circuitry 206), and one or more filters to generate RF signals for subsequent transmission (e.g., by one or more of the one or more antennas 210.

In some embodiments, the STA 200 may include additional elements such as, for example, memory/storage, display, camera, sensor, and/or input/output (I/O) interface as described in more detail below. In some embodiments, the STA 200 described herein may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or other device that may receive and/or transmit information wirelessly. In some embodiments, the STA 200 may include one or more user interfaces designed to enable user interaction with the system and/or peripheral component interfaces designed to enable peripheral component interaction with the system. For example, the STA 200 may include one or more of a keyboard, a keypad, a touchpad, a display, a sensor, a non-volatile memory port, a universal serial bus (USB) port, an audio jack, a power supply interface, one or more antennas, a graphics processor, an application processor, a speaker, a microphone, and other I/O components. The display may be an LCD or LED screen including a touch screen. The sensor may include a gyro sensor, an accelerometer, a proximity sensor, an ambient light sensor, and a positioning unit. The positioning unit may communicate with components of a positioning network, e.g., a global positioning system (GPS) satellite.

The antenna 210 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 210 may be effectively separated to take advantage of spatial diversity and the different channel characteristics that may result.

Although the STA 200 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

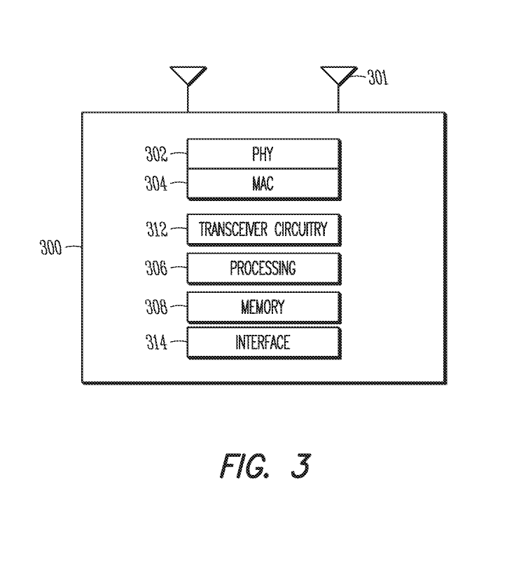

FIG. 3 is a block diagram of a communication device in accordance with some embodiments. The device may be a STA or AP or NAN2 device, for example, such as the STA 102 or AP 104 shown in FIG. 1. The communication device 300 may include physical layer circuitry 302 and transceiver circuitry 312 for transmitting and receiving signals to and from one or more APs, STAs or other devices using one or more antennas 301. The communication device 300 may also include medium access control layer (MAC) circuitry 304 for controlling access to the wireless medium. The communication device 300 may also include processing circuitry 306, such as one or more single-core or multi-core processors, and memory 308 arranged to perform the operations described herein. The communication device 300 may also include wired and/or wireless interfaces 310 to communicate with components external to the network. The physical layer circuitry 302, MAC circuitry 304 and processing circuitry 306 may handle various radio control functions that enable communication with one or more radio networks compatible with one or more radio technologies. The radio control functions may include signal modulation, encoding, decoding, radio frequency shifting, etc. For example, similar to the device shown in FIG. 2, in some embodiments, communication may be enabled with one or more of a WMAN, a WLAN, and a WPAN. In some embodiments, the communication device 300 can be configured to operate in accordance with 3GPP standards or other protocols or standards, including WiMax, WiFi, GSM, EDGE, GERAN, UMTS, UTRAN, or other 3G, 3G, 4G, 5G, etc. technologies either already developed or to be developed. The physical layer circuitry 202, MAC layer circuitry 304, transceiver circuitry 312, processing circuitry 308, memory 308 and interfaces 310 may be separate components or may be part of a combined component.

The antennas 301 may comprise one or more directional or omnidirectional antennas, including, for example, dipole antennas, monopole antennas, patch antennas, loop antennas, microstrip antennas or other types of antennas suitable for transmission of RF signals. In some MIMO embodiments, the antennas 301 may be effectively separated to take advantage of spatial diversity and the different channel characteristics that may result.

Although the communication device 300 is illustrated as having several separate functional elements, one or more of the functional elements may be combined and may be implemented by combinations of software-configured elements, such as processing elements including DSPs, and/or other hardware elements. For example, some elements may comprise one or more microprocessors, DSPs, FPGAs, ASICs, RFICs and combinations of various hardware and logic circuitry for performing at least the functions described herein. In some embodiments, the functional elements may refer to one or more processes operating on one or more processing elements. Embodiments may be implemented in one or a combination of hardware, firmware and software. Embodiments may also be implemented as instructions stored on a computer-readable storage device, which may be read and executed by at least one processor to perform the operations described herein.

In some embodiments, the communication device 300 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly.

In some embodiments, the communication device 300 may communicate using OFDM communication signals over a multicarrier communication channel. Accordingly, in some cases the communication device 300 may be configured to receive signals in accordance with specific communication standards, such as the Institute of Electrical and Electronics Engineers (IEEE) standards including IEEE 802.11-2012, 802.11n-2009 and/or 802.11ac-2013 standards and/or proposed specifications for WLANs including proposed HE standards, although the scope of the disclosure is not limited in this respect as they may also be suitable to transmit and/or receive communications in accordance with other techniques and standards. In some other embodiments, the communication device 300 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In accordance with embodiments, the communication device 300 may transmit an SM-OFDM signal that comprises multiple OFDM signals, and the SM-OFDM signal may be received at the communication device 300. The SM-OFDM signal may be transmitted in channel resources that comprise multiple sub-carriers and the OFDM signals may be based at least partly on data symbols for used data portions of the sub-carriers. The used data portions may be based on a first portion of encoded bits and the data symbols for the used data portions may be based on a second portion of the encoded bits. In some examples, the used data portions of the sub-carriers may be different for at least some of the OFDM signals.

In some embodiments, the channel resources may be used for downlink transmission and for uplink transmissions by the communication device 300. That is, a time-division duplex (TDD) format may be used. In some cases, the channel resources may include multiple channels, such as the 20 MHz channels previously described. The channels may include multiple sub-channels or may be divided into multiple sub-channels for the uplink transmissions to accommodate multiple access for multiple communication devices 300. The downlink transmissions may or may not utilize the same format.

In some embodiments, the downlink sub-channels may comprise a predetermined bandwidth. As a non-limiting example, the sub-channels may each span 2.03125 MHz, the channel may span 20 MHz, and the channel may include eight or nine sub-channels. Although reference may be made to a sub-channel of 2.03125 MHz for illustrative purposes, embodiments are not limited to this example value, and any suitable frequency span for the sub-channels may be used. In some embodiments, the frequency span for the sub-channel may be based on a value included in an 802.11 standard (such as 802.11ax), a 3GPP standard or other standard.

In some embodiments, the sub-channels may comprise multiple sub-carriers. Although not limited as such, the sub-carriers may be used for transmission and/or reception of OFDM or OFDMA signals. As an example, each sub-channel may include a group of contiguous sub-carriers spaced apart by a pre-determined sub-carrier spacing. As another example, each sub-channel may include a group of non-contiguous sub-carriers. That is, the channel may be divided into a set of contiguous sub-carriers spaced apart by the pre-determined sub-carrier spacing, and each sub-channel may include a distributed or interleaved subset of those sub-carriers. The sub-carrier spacing may take a value such as 78.125 kHz, 312.5 kHz or 15 kHz, although these example values are not limiting. Other suitable values that may or may not be part of an 802.11 or 3GPP standard or other standard may also be used in some cases. As an example, for a 78.125 kHz sub-carrier spacing, a sub-channel may comprise 26 contiguous sub-carriers or a bandwidth of 2.03125 MHz.

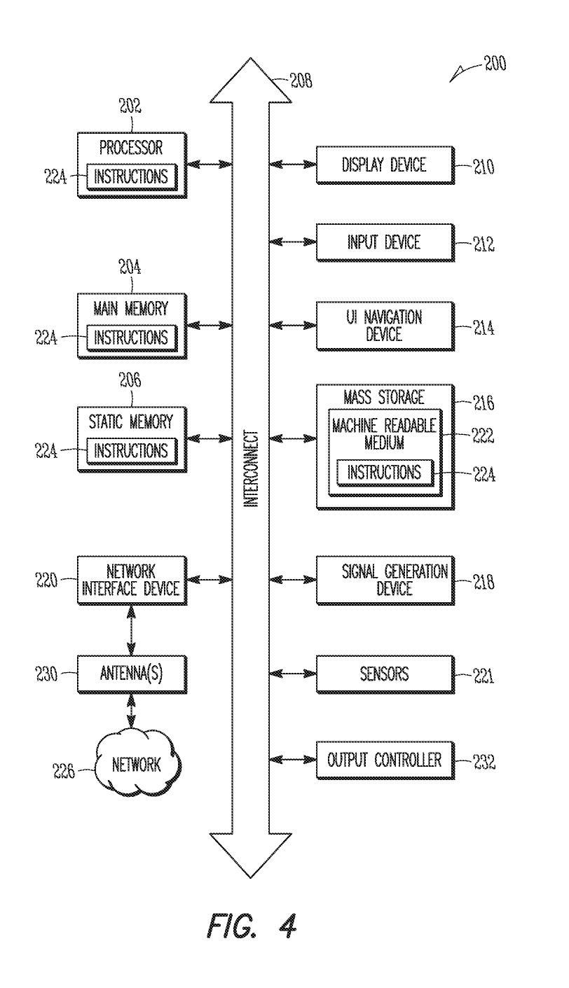

FIG. 4 illustrates another block diagram of a communication device in accordance with some embodiments. In alternative embodiments, the communication device 400 may operate as a standalone device or may be connected (e.g., networked) to other communication devices. In a networked deployment, the communication device 400 may operate in the capacity of a server communication device, a client communication device, or both in server-client network environments. In an example, the communication device 400 may act as a peer communication device in peer-to-peer (P2P) (or other distributed) network environment. The communication device 400 may be an AP or a STA device, such as a PC, a tablet PC, a STB, a PDA, a mobile telephone, a smart phone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Communication device (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The communication device 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The communication device 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The communication device 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a communication device readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the communication device 400. In an example, one or any combination of the hardware processor 402, the main memory 404, the static memory 406, or the storage device 416 may constitute communication device readable media.

While the communication device readable medium 422 is illustrated as a single medium, the term “communication device readable medium” may include a single medium or multiple media (e.g., a centralized or distributed database, and/or associated caches and servers) configured to store the one or more instructions 424.

The term “communication device readable medium” may include any medium that is capable of storing, encoding, or carrying instructions for execution by the communication device 400 and that cause the communication device 400 to perform any one or more of the techniques of the present disclosure, or that is capable of storing, encoding or carrying data structures used by or associated with such instructions. Non-limiting communication device readable medium examples may include solid-state memories, and optical and magnetic media. Specific examples of communication device readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device readable media may include non-transitory communication device readable media. In some examples, communication device readable media may include communication device readable media that is not a transitory propagating signal.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., IEEE 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), MIMO, or multiple-input single-output (MISO) techniques. In some examples, the network interface device 420 may wirelessly communicate using Multiple User MIMO techniques. The term “transmission medium” shall be taken to include any intangible medium that is capable of storing, encoding or carrying instructions for execution by the communication device 400, and includes digital or analog communications signals or other intangible medium to facilitate communication of such software.

As above, it would be desirable to enable improved low power operation for Wi-Fi STAs (LPs), in addition to potentially extending the range of operation for those STAs. Among the use cases for low power operation are enabling non-rechargeable battery operated sensors and IoT devices in smart homes and smart building management, for example a temperature sensor in a HVAC duct, which cannot be reached easily. Such a STA may require on the order of at least five years of battery life under operating conditions for which the STA was designed to function.

Unlike IEEE 802.11ah, IEEE 802.11 LP STAs may operate in the 2.4 GHz and 5 GHz bands. Moreover, LP STAs may be able to use bandwidths smaller than the standard 20 MHz bandwidth channels used in other IEEE 802.11 systems to enable low power data transfer. Thus, LP systems may have to address legacy IEEE 802.11 system coexistence issues that have not previously been a concern in development of IEEE 802.11ah and other IEEE 802.11 systems. Unlike IEEE 802.11ax (HE), where OFDMA operation allows smaller bandwidths, the use of LP may enable the use of STAs that only operate with a bandwidth smaller than 20 MHz, for example approximately to 2 MHz to 2.6 MHz. For IEEE 802.11ax OFDMA modes, for example, which are able to communicate via smaller bandwidth signals in a particular 20 MHz channel, even when a STA transmits a narrowband signal (2 MHz, 5 MHz or therebetween), for coexistence purposes the STA may first transmit a legacy preamble at 20 MHz. Thus, mechanisms to allow LP STAs to coexist with legacy STAs may be developed as the previously used method of transmission of a 20 MHz legacy preamble may not be possible for LP STAs that operate only using a narrow bandwidth.

The discussions herein describe the transmission power limitations of IoT devices (LP STAs) due to the limitations on battery type and battery life in such devices, as well as the associated impact on the range of operation of such devices due to the limited transmission power. To address range and coverage issues, the use of AC-powered STAs (referred to herein as Assisting STA) is suggested to act as a relay, repeater or mesh node to assist with extending the coverage of the LP STAs beyond the inherent LP range. The Assisting STAs, as discussed in more detail below, may be capable of 20 MHz communications (transmission and reception) in order to initiate transmission with a legacy preamble, which may thereby enable coexistence with other IEEE 802.11 systems.

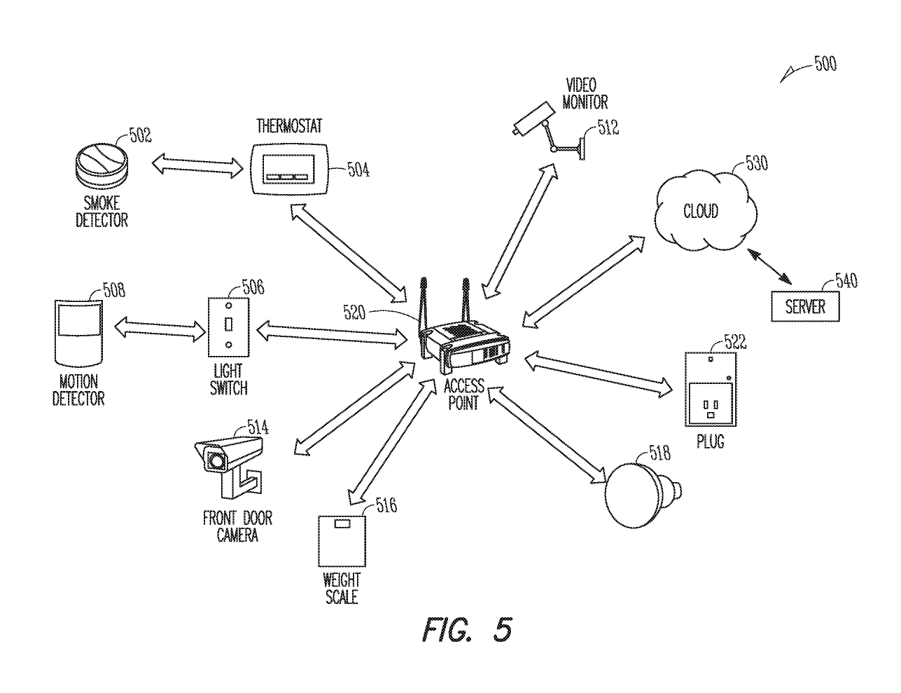

FIG. 5 illustrates a home environment in accordance with some embodiments. The STAs and other devices shown may be those shown in any of FIGS. 1-4. The home environment 500 may include a variety of individual devices, including environmental controls such as thermostats 502, smoke (or CO₂) detectors 504 and light switches 506, security devices such as motion detectors 508, video monitors 512 and front (or rear/side) door cameras 514, appliances such as refrigerators or weight scales 516, and electrical devices, such as smart light bulbs 518 and plugs 522. Each of these devices may communicate, directly or through a relay, with an AP 520. The AP 520, in turn, may communicate with the cloud 530 and from there to one or more servers 540, which may be in the cloud 530 or, as shown, isolated from the cloud. The home environment may be disposed in a residence or office, for example.

At least some of the STAs may be LP STAs, such as the smoke detector 504, motion detector 508 or weight scale 516 and may have a small transmission range due to having limited power for transmission. The transmission power of the various STAs may be limited to reduce the drain on a non-rechargeable battery from which the device draws power to ensure long battery life and to minimize the peak current draw on the battery. A long battery life may permit the motion sensor 508, for example (or other sensors or controllers in the environment), to be installed in locations that are inconvenient to regularly and easily access to change or recharge the battery. The transmission power limitation due to battery type and battery life may impact the transmission range of these STAs. Due to the low transmission power, the manner in which the signal from the sensor and other IoT STAs reaches an AP, which may not be located conveniently locally (i.e., within transmission range) with the sensor, may be problematic for delivery of reports, reception of updates, or other information to be communicated with the particular STA and the cloud 530.

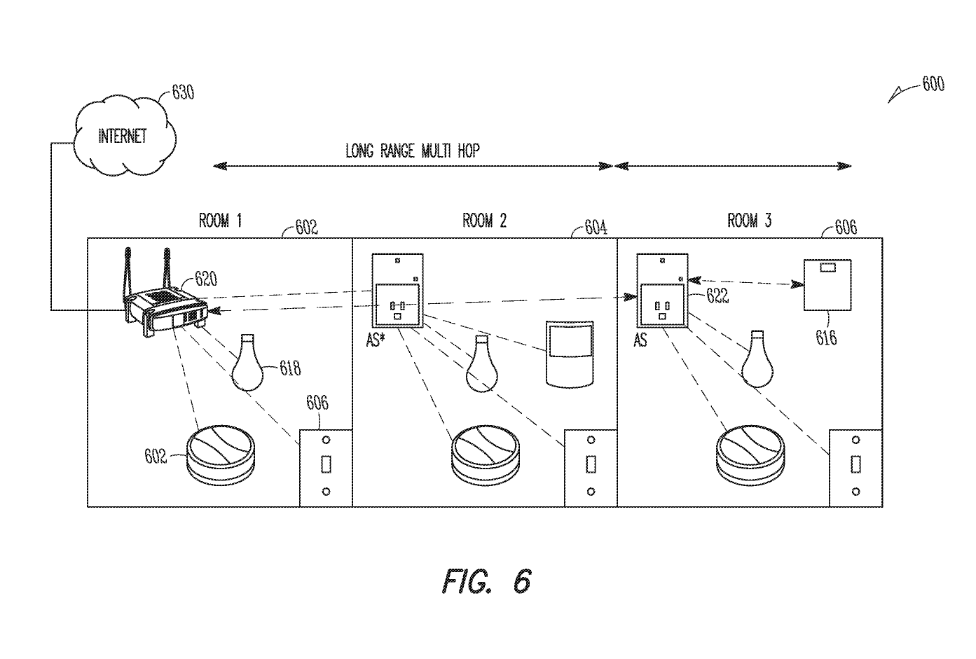

However, not all of the LP STAs shown in FIG. 5 may be in the same room or within transmission range of the AP. FIG. 6 illustrates a multi-room environment 600 in accordance with some embodiments. The various LP STAs of FIG. 5 may be distributed through multiple rooms 602, 604, 606. The AP 620, which is in wireless or wired communication with the internet 630 and/or the cloud, may be in one of the rooms 602. Some or all of the LP STAs such as a smoke detector 602, a light switch 606 and a lightbulb 618 may in the room 602 may be able to communicate with the AP 620. Other LP STAs in other rooms 604, 606, such as a weight scale 616 may not be able to transmit directly to the AP 620, although such LP STAs may be able to receive communications directly from the AP 620. To reach the AP 620, the LP STAs outside of direct transmission range may employ an AC-powered Assisting STA 622 as a communication hop. As the Assisting STA 622 may be AC-power and have no power consumption constraints, the Assisting STA 622 may thus be used to act as relay or repeater, or as a mesh node in a mesh network in which the LP STAs are disposed, to assist with extending the coverage of the LP STAs beyond the initial operating transmission range.

In FIG. 6, for example the LP STA 616 (shown as a weight scale) in a particular room 606 may receive communications directly from the AP 620, which is in a different room. However, when the LP STA 616 determines that a transmission to the AP 620 is desired, the LP STA 616 may transmit to the Assisting STA 622 in the particular room 606. The Assisting STA 622 may be disposed in a light switch, as shown, for example. The Assisting STA 622 may have a more extensive transmission range than the LP STA 616 and may transmit directly to the AP 620 as shown, or may transmit to another Assisting STA 622 in another room 604 more proximate to the AP 620. The transmissions between LP STA 616 and the Assisting STA 622 and the Assisting STA 622 and the AP 620 (and perhaps Assisting STA 622) may use the same channel or may use different channels. Whether the transmission from the Assisting STA 622 to the AP 620 is direct or indirect may depend, for example, on relative channel quality of the channels used in the different transmission paths, latency and/or importance of the data being transmitted, among others. The data being transmitted from the LP STA 616 may be polled by the Assisting STA and may be either periodic or event driven. For example, data from a thermostat may be periodic to permit temperature regulation, while for a smoke detector or weight scale may be event driven, such as when the weight scale takes a measurement.

In addition to having a low transmission power, however, further measures may be taken to further extend the battery life. As above, one of these measures may include reducing the bandwidth of operation of the LP STA, but not the Assisting STA or AP, to be substantially narrower than the legacy 20 MHz Wi-Fi operation. Limiting the LP STA to a narrow bandwidth of operation may further help to lower total device power consumption during communication, both transmission and reception. As used herein, narrowband STAs may be limited to only being able to communicate using a bandwidth substantially less than 20 MHz, such as about 2 MHz-5 MHz.

Unfortunately, due to legacy STAs operating in the 2.4 GHz and 5 GHz bands, narrow bandwidth operation may create an issue with coexistence with legacy STAs when an Assisting STA is used that merely acts as a relay. In current Wi-Fi standards, even for IEEE 802.11ax, all STAs must be able to transmit and receive at least 20 MHz. In many cases with later revisions, even larger than 20 MHz transmissions are used. In addition, there is no multi-hop deployment of Wi-Fi for IoT STAs. While a small bandwidth may be sufficient for some LP STAs that may transmit a relatively small amount of data, such as the motion sensor shown in FIG. 5, it may be desirable for other LP STAs, such as the front door camera shown in FIG. 5, to communicate using at least 20 MHz of bandwidth due to a high data rate requirement. In some circumstances, LP STA operations may be incompatible—e.g., a front door camera may not be able to detect a narrowband transmission of a motion sensor. This may be an issue not only if direct communications are to be attempted between the two STAs, but also, as the legacy STA may not be able to detect the narrowband LP STA transmission, may present an issue if both attempt to use the same channel; for example, the legacy STA may start a transmission while the LP STA is transmitting to the Assisting STA, or the Assisting STA is relaying LP STA data to the AP.

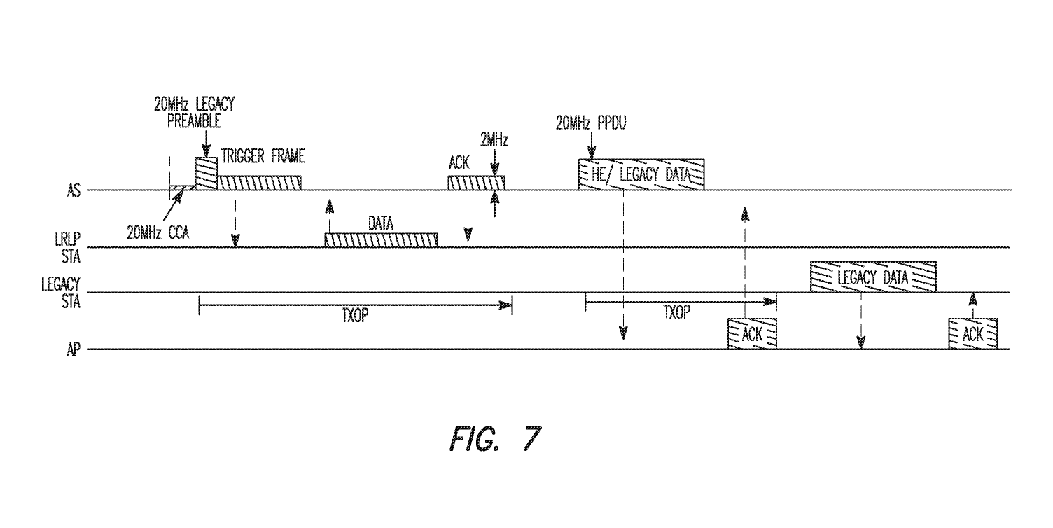

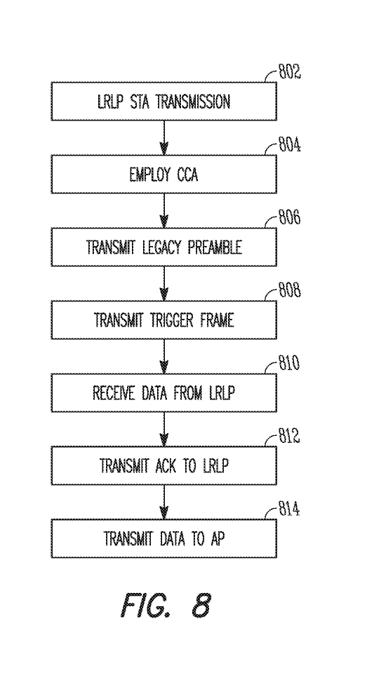

To address this coexistence issue, the Assisting STA may operate in 20 MHz bandwidth. In particular, the Assisting STA may be capable of both narrowband LP communications (also referred to herein as subchannel communications) and legacy 20 MHz communications in order to start transmissions using a legacy preamble prior to sending the narrowband preamble and data. The legacy preamble transmission may enable coexistence with legacy STAs. FIG. 7 illustrates system communications in accordance with some embodiments. The communications of the Assisting STA, the LP STA, the legacy STA and the AP, which may share the same medium (20 MHz channel), are shown in FIG. 7. The various STAs may be, for example, those shown in any of FIGS. 1-6. FIG. 8 is a flowchart of a communications between an Assisting STA and a LP STA in accordance with some embodiments.

As illustrated, the Assisting STA may initially determine, at operation 802, that data is to be transmitted by the LP STA to the AP. The timing for the transmission from the LP STA may be known by the Assisting STA in advance. In some embodiments, the transmission may be periodically reported data, e.g., data reported hourly or daily. In some embodiments, the data may be determined from a previous transmission from the LP STA to the AP. In this case, timing information may be provided in the previous transmission from the LP STA to the AP and then from the AP to the Assisting STA, directly from the LP STA to the Assisting STA. In some embodiments, the LP may indicate to the AP timing of the transmissions, and the AP may then provide the timing to the LP STA.

Prior to data transmission, the Assisting STA may adhere to current 20 MHz WLAN Clear Channel Assessment rules. This is to say that at operation 804 the Assisting STA may initially employ a Carrier Sense/Clear Channel Assessment (CS/CCA) technique to determine the state of the medium and ensure that the medium is free. The CS/CCA procedure may be executed while the Assisting STA is not currently receiving or transmitting a packet. The CS/CCA procedure may be used to detect the start of a network signal that can be received (CS) and to determine whether the channel is clear prior to transmitting a packet (CCA). During the CS/CCA procedure, each STA may maintain a backoff counter having random backoff time. The use of a random backoff time may help to reduce the collision probability between multiple STAs accessing a medium when collisions are most likely to occur, which may be immediately after the medium becomes free as multiple STAs may have been waiting for the medium to become available. A STA wishing to transmit a buffered data packet may first sense the channel to determine the channel status. If the channel is idle for a period of time greater than the DCF Inter Frame Space (DIFS) period and the backoff counter of the STA reaches zero, the STA may transmit the data packet during a transmission opportunity (TXOP). As described herein, the Assisting STA may undertake the CCA for both itself and the LP so that the Assisting STA and LP are able to transmit within the same TXOP. Other specifics, such as the use of request to send (RTS) and clear to send (CTS) transmissions, as well as time periods such as the Short Inter Frame Space (SIFS) period, Extended Inter Frame Space (EIFS) period, PCF Inter Frame Space (PIFS) period, and Arbitration Inter Frame Space period (AIFS), along with the associated network operations to provide contention-based or contention-free communications will not be discussed here for brevity. Thus, legacy STAs that received the legacy preamble may decode the legacy preamble and defer transmission.

After ensuring that the medium is available, the Assisting STA may initiate a transmission to the LP STA at operation 806. In particular, the Assisting STA may begin all transmissions to the LP STA using a 20 MHz legacy preamble in order to “spoof” legacy STAs without transmitting an entire legacy 802.11 signal. The preamble may contain a short and long training field used for packet acquisition, synchronization and channel estimation and a signal field that may indicate the length of the packet or the length of TXOP (up to a predetermined maximum length). The TXOP may nominally be about 3 ms and extend to 10 ms or longer. The amount of time for the TXOP may be previously negotiated between the Assisting STA and the LP STA or may be determined based on an expected amount of data from the particular LP STA. For example, the TXOP for data from a camera or video monitor, in which video data may be transmitted, may be longer than the TXOP for a thermometer or smoke detector. In some embodiments, the LP STA may not be able to detect and/or decode/use data transmitted over the entire 20 MHz channel. However, even though the LP STA may not be able to detect the legacy transmission, by transmitting the legacy preamble, other nearby HE/legacy STAs contending for the channel may sense the transmission and may restart their own CS/CCA operations. In some embodiments, the LP STA may be able to detect data transmitted over the entire 20 MHz channel but not transmit over the entire range of frequencies.

After transmission of the legacy preamble at operation 806, the Assisting STA may transmit a trigger frame to the LP STA at operation 808. The trigger frame may contain scheduling information for the LP STA, an address of the LP STA, and an address of the AP as well as another address (source, destination, and receiver addresses). For example, in some embodiments, the AP rather than the Assisting STA may transmit perform the downlink operations (CCA, legacy preamble and trigger frame transmission) described, so that the addresses may differ from embodiments in which the Assisting STA performs the downlink operations. The AP may transmit the preamble and perhaps the trigger frame when the signal strength is sufficient to reach the LP STA. The LP STA address may be the MAC address of the LP STA or may be a pre-negotiated ID of the LP STA. The scheduling information may indicate a length of packet for the LP to transmit as well as the manner of transmission, such as the modulation and coding scheme, subchannel, timing and other transmission characteristics.

The trigger frame may be transmitted using a narrowband transmission (e.g., a 2-5 MHz subchannel of the 20 MHz channel). In some embodiments, the Assisting STA may transmit the trigger frame to the LP STA on a subchannel that the LP STA is to transmit. In some embodiments, the LP STA may be able to communicate using only the subchannel, in which case the Assisting STA may transmit the trigger frame to the LP STA on that subchannel. In embodiments in which the LP STA is able to receive transmissions on all of or a portion of the channel (including the subchannel), the Assisting STA may transmit the trigger frame to the LP STA on a subchannel that the LP STA is to receive and that may or may not be the subchannel on which the LP STA is to transmit data. In some embodiments, the trigger frame may indicate the subchannel on which the LP STA is to transmit the data. In some embodiments, the trigger frame may contain an indication for the LP STA to transmit data, if the LP STA has any data to transmit, along with the timing of the data transmission. In some embodiments, the Assisting STA may multiplex multiple trigger frames so that the trigger frames may be simultaneously transmitted on different subchannels to different LP STAs. In these embodiments, the subchannel used by one or more of the LP STAs may be the same as the trigger frame or may be different than that used by the trigger frame. In some embodiments, only one trigger frame at a time may be transmitted by the Assisting STA.

In response to reception of the trigger frame, at operation 810 the LP STA may transmit a data packet on the subchannel, whether predetermined or indicated by the Assisting STA. The transmission may include the data, the address of the Assisting STA, the AP and/or a final address of a STA other than both the Assisting STA or AP. The final address may be the AP address or a server or STA, for example, connected to the AP through the internet. In some embodiments, data may not include the destination, the Assisting STA may instead store the AP-LP STA relationship and transmit any data from the LP STA to the AP. Timing between trigger frame and data transmission may be predetermined, e.g., as the minimum time for decoding of the trigger frame, or may be determined based on other simultaneous data transmissions on other subchannels in the channel (e.g., if some data transmissions during the TXOP are longer than others). In some embodiments the trigger frame and response may have the same bandwidth and in other embodiments the trigger frame and response may have different bandwidths, both of which are smaller than the channel bandwidth. The data for multiple TXOPs may be aggregated by the Assisting STA or AP.

Upon reception of the data packet from LP STA, at operation 812 the Assisting STA may reply to the LP STA with an ACK acknowledging reception of the narrowband packet from the LP STA. The ACK may be transmitted about 16 s after reception and decoding of the data. The ACK may be on the same subchannel as the data and/or trigger frame. If the Assisting STA does not receive the data from the LP STA within a predetermined amount of time from the end of the trigger frame, the Assisting STA may transmit another trigger signal (in addition to the preamble) to the LP STA in a new TXOP. As above, the communication with the LP STA, including preamble, trigger frame, data and ACK may occur within a TXOP associated with the initial CCA.

Assuming the data has been received from the LP STA at operation 810, after the ACK has been transmitted at operation 812, the Assisting STA may subsequently forward the received data packet to the AP (or whatever the final destination in indicated in the data packet) at operation 814. The transmission may be sent directly to the AP or may hop through one or more other Assisting STAs. The transmission to the AP may use a 20 MHz or higher bandwidth mode (e.g. IEEE 802.11ax). The transmission from the Assisting STA to the AP may use the same channel (and contention mechanism above) or may use an entirely different channel than the transmission from Assisting STA to the LP STA. The Assisting STA may again contend for whichever channel is used to transmit the data from the LP STA to the AP, as shown. As shown, the AP, upon receiving the data from the LP STA, transmitted through the Assisting STA, may transmit an ACK to the Assisting STA. The Assisting STA may then interact (transmitting and receiving data, ACKs and control signals, among others) with the legacy STAs in a legacy manner.

In some embodiments, the LP STA may be able to switch between battery power and AC power, or some other renewable power source. In this case, transmissions between the Assisting STA and the LP STA may continue to be limited to a subchannel independent of which power source the LP STA is using, or may toggle such that when the LP STA is other than battery powered, transmissions between the Assisting STA and the LP STA may use the entire channel or otherwise revert to legacy communications. The LP STA may indicate to the Assisting STA that a source of power other than battery is being used either before or after the trigger frame is transmitted in a separate communication. Alternatively, the LP STA may simply receive the subchannel trigger frame and provide the requested data using the entire channel, thereby indicating that the ACK may be transmitted over the channel. In subsequent communications, for example, if further data is to be communicated in a short amount of time (e.g., up to several seconds or minutes), the Assisting STA and the LP STA may continue to use legacy communications.

### Examples

The subject matter of Example 1 includes an apparatus of an Assisting station (STA), the apparatus comprising: a memory; and processing circuitry in communication with the memory, the processing circuitry arranged to: generate a trigger frame for transmission following a 20 MHz legacy preamble, the trigger frame comprising a narrowband bandwidth smaller than a bandwidth of the legacy preamble, the trigger frame configured to be compatible with reception by a Low-Power (LP) STA; decode a response from the LP STA in response to transmission of the trigger frame, the response comprising data of the LP STA and an address of the Assisting STA, the trigger frame comprising a 2 MHz-5 MHz bandwidth; and after reception of the response, generate an assisting communication comprising the data for transmission to another STA different than the Assisting STA.

In Example 2, the subject matter of Example 1 optionally includes, wherein: the other STA is an access point (AP), and the assisting communication is generated for direct transmission to the AP, the response having insufficient power for the AP to detect the response.

In Example 3, the subject matter of Example 2 optionally includes, wherein the processing circuitry is further arranged to: decode an acknowledgment (ACK) from the AP in response to the transmission of the assisting communication.

In Example 4, the subject matter of Example 3 optionally includes, wherein the processing circuitry is further arranged to: perform a clear channel assessment (CCA), for a transmission opportunity (TXOP), prior to transmission of the preamble, wherein transmission of the trigger frame and ACK and reception of the response occur within the TXOP.

In Example 5, the subject matter of any one or more of Examples 3-4 optionally include or 4, wherein: the apparatus is AC-powered and the LP STA is battery powered, and selection of which of a wideband and narrowband transmission to use for transmission to the LP STA is independent of a manner in which the LP STA is powered.

In Example 6, the subject matter of any one or more of Examples 1-5 optionally include or 2, wherein: the trigger frame and the response are transmitted on a same subchannel, the preamble generated for transmission on a channel comprising the subchannel.

In Example 7, the subject matter of any one or more of Examples 1-6 optionally include or 2, wherein: the trigger frame is configured to indicate a subchannel for transmission of the response, the preamble generated for transmission on a channel comprising the subchannel.

In Example 8, the subject matter of any one or more of Examples 1-7 optionally include or 2, wherein: the trigger frame and the response are transmitted on different subchannels, the preamble generated for transmission on a channel comprising the subchannels.

In Example 9, the subject matter of any one or more of Examples 1-8 optionally include or 2, wherein the processing circuitry is further arranged to: generate a plurality of trigger frames for simultaneous transmission to different LP STAs using different subchannels.

In Example 10, the subject matter of any one or more of Examples 1-9 optionally include or 2, wherein: the trigger frame is configured to indicate a period for transmission of the response.

In Example 11, the subject matter of any one or more of Examples 1-10 optionally include or 2, wherein the processing circuitry is further arranged to: generate a narrowband acknowledgment (ACK) in response to reception of the response, the trigger frame, the ACK and the response comprising a same bandwidth.

In Example 12, the subject matter of any one or more of Examples 1-11 optionally include or 2, further comprising: an antenna configured to communicate with the LP STA and the other STA.

The subject matter of Example 13 includes an apparatus of a Low-Power (LP) station (STA), the apparatus comprising: a memory; and processing circuitry in communication with the memory, the processing circuitry arranged to: decode a trigger frame received on a smaller bandwidth than legacy communications, the smaller bandwidth being 2 MHz-5 MHz and the legacy communications having a bandwidth of 20 MHz; and generate a response in response to reception of the trigger frame, the response comprising data of the LP STA and at least one of an address of an Assisting STA and an address of an access point (AP) for transmission by the Assisting STA to the AP, the response comprising a smaller bandwidth than the legacy communications.

In Example 14, the subject matter of Example 13 optionally includes, wherein: the processing circuitry is further arranged to decode a narrowband acknowledgment (ACK) from one of the Assisting STA or the AP in response to transmission of the response to the Assisting STA, and the trigger frame, the response and the ACK comprise a same bandwidth.

In Example 15, the subject matter of Example 14 optionally includes, wherein: communications with the Assisting STA occur within a transmission opportunity (TXOP) associated with a clear channel assessment (CCA), and the communications comprise the trigger frame, the narrowband response and the ACK.

In Example 16, the subject matter of Example 15 optionally includes, wherein: wherein the communications occur on a same subchannel of a channel associated with another communication by the Assisting STA during the TXOP.

In Example 17, the subject matter of any one or more of Examples 13-16 optionally include or 14, wherein the processing circuitry is further arranged to: avoid performance of a clear channel assessment (CCA) for the response prior to transmission of the response.

In Example 18, the subject matter of any one or more of Examples 13-17 optionally include or 14, wherein: the trigger frame indicates a subchannel for transmission of the response, and the preamble is transmitted on a channel comprising the subchannel.

In Example 19, the subject matter of Example 18 optionally includes, wherein: the trigger frame is received on a different subchannel than the subchannel for transmission of the response.

In Example 20, the subject matter of any one or more of Examples 13-19 optionally include or 14, wherein: the trigger frame is configured to indicate a period for transmission of the response.

Example 21 is a method, performed by an Assisting station (STA) of providing communications, the method comprising: obtain a transmission opportunity (TXOP) after performing a clear channel assessment (CCA), during the TXOP: transmitting, a Low-Power (LP) STA, a wideband preamble and a narrowband trigger frame comprising a smaller bandwidth than the preamble; receiving a narrowband response from the LP STA in response to transmission of the trigger frame, the response comprising data of the LP STA and an address of an access point (AP), the response having a transmission range less than a distance from the LP STA to the AP; and after reception of the response, transmitting a wideband communication containing the data to the AP.

In Example 22, the subject matter of Example 21 optionally includes, wherein: the trigger frame and the response each comprises a bandwidth of about 2-5 MHz, and the wideband communication and the preamble each comprises a bandwidth of at least 20 MHz.

In Example 23, the subject matter of any one or more of Examples 21-22 optionally include or 22, further comprising: transmitting the preamble on a channel comprising a subchannel; and transmitting the trigger frame and the response on the subchannel.

In Example 24, the subject matter of any one or more of Examples 21-23 optionally include or 22, further comprising: limiting transmission of the trigger frame to a 2 MHz-5 MHz subchannel on which the LP STA is able to transmit.

In Example 25, the subject matter of any one or more of Examples 21-24 optionally include or 22, further comprising: during the TXOP, transmitting a narrowband acknowledgment (ACK) in response to reception of the response, wherein the trigger frame, the ACK and the response comprising a same bandwidth.

Example 26 is a non-transitory computer-readable storage medium that stores instructions for execution by one or more processors of a station (STA) to configure the STA to: establish a first transmission opportunity (TXOP) for communication with a Low-Power (LP) STA and a second TXOP for communication with an access point; transmit a wideband preamble on a channel and a narrowband trigger frame on a subchannel, the subchannel comprising a smaller bandwidth than the channel; receive a narrowband response from the LP STA in response to transmission of the trigger frame, the response comprising data of the LP STA and an address of the AP; transmit a narrowband acknowledgment (ACK) in response to reception of the response, the trigger frame, the response and the ACK comprising a same bandwidth; and after reception of the response, transmit a wideband communication containing the data to the AP.

In Example 27, the subject matter of Example 26 optionally includes, wherein: the trigger frame, the ACK and the response each comprises a bandwidth of at most 2 MHz, and the wideband communication and the preamble each comprises a bandwidth of at least 20 MHz.

In Example 28, the subject matter of any one or more of Examples 26-27 optionally include or 27, wherein the instructions further configure the STA to: limit transmission of the trigger frame to a 2 MHz-5 MHz subchannel on which the LP STA is able to transmit.

In Example 29, the subject matter of any one or more of Examples 26-28 optionally include or 27, wherein the instructions further configure the STA to: limit communication with the LP STA to communication over the subchannel.

Example 30 is an apparatus of a station (STA) comprising: means for establishing a first transmission opportunity (TXOP) for communication with a Low-Power (LP) STA and a second TXOP for communication with an access point; means for transmitting a wideband preamble on a channel and a narrowband trigger frame on a subchannel, the subchannel comprising a smaller bandwidth than the channel; means for receiving a narrowband response from the LP STA in response to transmission of the trigger frame, the response comprising data of the LP STA and an address of the AP; means for transmitting a narrowband acknowledgment (ACK) in response to reception of the response, the trigger frame, the response and the ACK comprising a same bandwidth; and after reception of the response, means for transmitting a wideband communication containing the data to the AP.

In Example 31, the subject matter of Example 30 optionally includes, wherein: the trigger frame, the ACK and the response each comprises a bandwidth of at most 2 MHz, and the wideband communication and the preamble each comprises a bandwidth of at least 20 MHz.

In Example 32, the subject matter of any one or more of Examples 30-31 optionally include or 31, further comprising: means for limiting transmission of the trigger frame to a 2 MHz-5 MHz subchannel on which the LP STA is able to transmit.

In Example 33, the subject matter of any one or more of Examples 30-32 optionally include or 31, further comprising: means for limiting communication with the LP STA to communication over the subchannel.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be discussed without intending to voluntarily limit the scope of this application to any single embodiment or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

1. An apparatus of an Assisting station (STA), the apparatus comprising:
a memory; and
processing circuitry in communication with the memory, the processing circuitry arranged to:
generate a trigger frame for transmission following a 20 MHz legacy preamble, the trigger frame comprising a narrowband bandwidth smaller than a bandwidth of the legacy preamble, the trigger frame configured to be compatible with reception by a Low-Power (LP) STA;
decode a response from the LP STA in response to transmission of the trigger frame, the response comprising data of the LP STA and an address of the Assisting STA, the trigger frame comprising a 2 MHz-5 MHz bandwidth; and
after reception of the response, generate an assisting communication comprising the data for transmission to another STA different than the Assisting STA.

2. The apparatus of claim 1, wherein:
the other STA is an access point (AP), and
the assisting communication is generated for direct transmission to the AP, the response having insufficient power for the AP to detect the response.

3. The apparatus of claim 2, wherein the processing circuitry is further arranged to:
decode an acknowledgment (ACK) from the AP in response to the transmission of the assisting communication.

4. The apparatus of claim 3, wherein the processing circuitry is further arranged to:
perform a clear channel assessment (CCA), for a transmission opportunity (TXOP), prior to transmission of the preamble,
wherein transmission of the trigger frame and ACK and reception of the response occur within the TXOP.

5. The apparatus of claim 3, wherein:
the apparatus is AC-powered and the LP STA is battery powered, and selection of which of a wideband and narrowband transmission to use for transmission to the LP STA is independent of a manner in which the LP STA is powered.

6. The apparatus of claim 1, wherein:
the trigger frame and the response are transmitted on a same subchannel, the preamble generated for transmission on a channel comprising the subchannel.

7. The apparatus of claim 1, wherein:
the trigger frame is configured to indicate a subchannel for transmission of the response, the preamble generated for transmission on a channel comprising the subchannel.

8. The apparatus of claim 1, wherein:
the trigger frame and the response are transmitted on different subchannels, the preamble generated for transmission on a channel comprising the subchannels.

9. The apparatus of claim 1, wherein the processing circuitry is further arranged to:
generate a plurality of trigger frames for simultaneous transmission to different LP STAs using different subchannels.

10. The apparatus of claim 1, wherein:
the trigger frame is configured to indicate a period for transmission of the response.

11. The apparatus of claim 1, wherein the processing circuitry is further arranged to:
generate a narrowband acknowledgment (ACK) in response to reception of the response, the trigger frame, the ACK and the response comprising a same bandwidth.

12. The apparatus of claim 1, further comprising:
an antenna configured to communicate with the LP STA and the other STA.

13. An apparatus of a Low-Power (LP) station (STA), the apparatus comprising:
a memory; and
processing circuitry in communication with the memory, the processing circuitry arranged to:
decode a trigger frame received on a smaller bandwidth than legacy communications, the smaller bandwidth being 2 MHz-5 MHz and the legacy communications having a bandwidth of 20 MHz; and
generate a response in response to reception of the trigger frame, the response comprising data of the LP STA and at least one of an address of an Assisting STA and an address of an access point (AP) for transmission by the Assisting STA to the AP, the response comprising a smaller bandwidth than the legacy communications.

14. The apparatus of claim 13, wherein:
the processing circuitry is further arranged to decode a narrowband acknowledgment (ACK) from one of the Assisting STA or the AP in response to transmission of the response to the Assisting STA, and
the trigger frame, the response and the ACK comprise a same bandwidth.

15. The apparatus of claim 14, wherein:
communications with the Assisting STA occur within a transmission opportunity (TXOP) associated with a clear channel assessment (CCA), and
the communications comprise the trigger frame, the narrowband response and the ACK.

16. The apparatus of claim 15, wherein:
wherein the communications occur on a same subchannel of a channel associated with another communication by the Assisting STA during the TXOP.

17. The apparatus of claim 13, wherein the processing circuitry is further arranged to:
avoid performance of a clear channel assessment (CCA) for the response prior to transmission of the response.

18. The apparatus of claim 13, wherein:
the trigger frame indicates a subchannel for transmission of the response, and
the preamble is transmitted on a channel comprising the subchannel.

19. The apparatus of claim 18, wherein:
the trigger frame is received on a different subchannel than the subchannel for transmission of the response.

20. The apparatus of claim 13, wherein:
the trigger frame is configured to indicate a period for transmission of the response.

21. A method, performed by an Assisting station (STA) of providing communications, the method comprising:
obtain a transmission opportunity (TXOP) after performing a clear channel assessment (CCA), during the TXOP:
transmitting, a Low-Power (LP) STA, a wideband preamble and a narrowband trigger frame comprising a smaller bandwidth than the preamble;
receiving a narrowband response from the LP STA in response to transmission of the trigger frame, the response comprising data of the LP STA and an address of an access point (AP), the response having a transmission range less than a distance from the LP STA to the AP; and
after reception of the response, transmitting a wideband communication containing the data to the AP.

22. The method of claim 21, wherein:
the trigger frame and the response each comprises a bandwidth of about 2-5 MHz, and
the wideband communication and the preamble each comprises a bandwidth of at least 20 MHz.

23. The method of claim 21, further comprising:
transmitting the preamble on a channel comprising a subchannel; and
transmitting the trigger frame and the response on the subchannel.

24. The method of claim 21, further comprising:
limiting transmission of the trigger frame to a 2 MHz-5 MHz subchannel on which the LP STA is able to transmit.

25. The method of claim 21, further comprising:
during the TXOP, transmitting a narrowband acknowledgment (ACK) in response to reception of the response,
wherein the trigger frame, the ACK and the response comprising a same bandwidth.

26. A non-transitory computer-readable storage medium that stores instructions for execution by one or more processors of a station (STA) to configure the STA to:
establish a first transmission opportunity (TXOP) for communication with a Low-Power (LP) STA and a second TXOP for communication with an access point;
transmit a wideband preamble on a channel and a narrowband trigger frame on a subchannel, the subchannel comprising a smaller bandwidth than the channel;
receive a narrowband response from the LP STA in response to transmission of the trigger frame, the response comprising data of the LP STA and an address of the AP;
transmit a narrowband acknowledgment (ACK) in response to reception of the response, the trigger frame, the response and the ACK comprising a same bandwidth; and
after reception of the response, transmit a wideband communication containing the data to the AP.

27. The medium of claim 26, wherein:
the trigger frame, the ACK and the response each comprises a bandwidth of at most 2 MHz, and
the wideband communication and the preamble each comprises a bandwidth of at least 20 MHz.

28. The medium of claim 26, wherein the instructions further configure the STA to:
limit transmission of the trigger frame to a 2 MHz-5 MHz subchannel on which the LP STA is able to transmit.

29. The medium of claim 26, wherein the instructions further configure the STA to:
limit communication with the LP STA to communication over the subchannel.
